(19) United States
(12) Patent Application Publication
(10) Pub. No.: US 2012/0158922 A1
(43) Pub. Date: Jun. 21, 2012

(54) CHANGING DEVICE CONFIGURATION BASED ON MACHINE-READABLE CODES

(75) Inventors: Vikram Aggarwal, San Jose, CA (US); Jiten Vaidya, Sunnyvale, CA (US)

(73) Assignee: GOOGLE INC., Mountain View, CA (US)

(21) Appl. No.: 13/249,822

(22) Filed: Sep. 30, 2011

Related U.S. Application Data
(63) Continuation of application No. 12/970,490, filed on Dec. 16, 2010.

(51) Int. Cl. G06F 15/177

(52) U.S. Cl. 709/220

(57) ABSTRACT

In general, this disclosure describes techniques for providing users of computing devices the ability to connect to a network using a computer-generated image. A subscriber to a network with access to the network through a network device can generate a computer-generated image that encodes network configuration information corresponding to the network device. These techniques allow a user with a computing device to scan the computer-generated image, launching a reader application to decode the encoded network configuration information. The network configuration information may be automatically used to configure a network interface on the computing device to connect to the network. The network connection may be initiated and configured without requiring user input other than capturing the computer-generated image.

This application is a continuation of U.S. application Ser. No. 12/970,490, filed Dec. 16, 2010, the entire contents of which are hereby incorporated by reference.

### TECHNICAL FIELD

This disclosure relates to processing user input on a computing device.

### BACKGROUND

Users of computing devices often wish to connect to an available network. For example, a coffee shop owner or a friend may be a subscriber of a larger network, and set up a wireless network to share the larger network. The wireless network access may be a secure connection and may require entering a password or phrase that includes a random sequence of alphanumeric characters. A user of a computing device, who wishes to connect to the network, configures the network connection on his/her computing device by inputting configuration information associated with the desired network into a network configuration application. Once the user completes inputting the configuration information, the user selects to connect to the network.

### SUMMARY

In general, this disclosure describes techniques for providing a user of a computing device with the ability to easily and quickly configure a network connection and access a network provided by a subscriber to the network. The network configuration information may be encoded using a computer-generated image, which may be provided by the subscriber to the user. These techniques allow scanning and decoding the computer-generated image by the computing device, and automatically configuring a network connection using the network configuration information.

In one example, the disclosure is directed to a method comprising scanning, by a computing device, a computer-readable image that includes encoded access control information associated with a network device that provides access to a network, wherein the access control information comprises one or more network parameters used by the network device to authorize access to the network, decoding, by the first computing device, the encoded access control information to obtain the access control information, and configuring the first computing device with the decoded access control information, wherein the configured first computing device is able to access the network using the network device.

In another example, the disclosure is directed to a computer-readable storage medium encoded with instructions that, when executed, cause one or more processors to scan, by a first computing device, a computer-readable image that includes encoded access control information associated with a network device that provides access to a network, wherein the access control information comprises one or more network parameters used by the network device to authorize access to the network, decode, by the first computing device, the encoded access control information to obtain the access control information, and configure the first computing device with the decoded access control information, wherein the configured first computing device is able to access the network using the network device.

In another example, the disclosure is directed to a computing device comprising one or more processors, an image capture module operable by the one or more processors to scan a computer-readable image that includes encoded access control information associated with a network device that provides access to a network, wherein the access control information comprises one or more network parameters used by the network device to authorize access to the network, a module operable by the one or more processors to decode the encoded access control information to obtain the access control information, and means for configuring the computing device with the decoded access control information, wherein the configured first computing device is able to access the network using the network device.

In another example, the disclosure is directed to a computing device comprising one or more processors, an image capture module operable by the one or more processors to scan a computer-readable image that includes encoded access control information associated with a network device that provides access to a network, wherein the access control information comprises one or more network parameters used by the network device to authorize access to the network, a reader application module operable by the one or more processors to decode the encoded access control information to obtain the access control information, and a network configuration application operable by the one or more processors to configure the computing device with the decoded access control information, wherein the configured computing device is able to access the network using the network device.

The techniques of this disclosure may provide one or more advantages. For example, certain techniques may allow a user of a computing device to quickly and easily connect to a network without requiring the user to manually input information that control access to the network. The network access control information may be encoded in a computer-generated image which is also computer-readable, which may be generated by a subscriber to the network. Scanning the computer-generated image by the user's computing device may automatically configure a network connection to provide network access to the computing device.

The details of one or more embodiments of the disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 is a block diagram illustrating an example system in accordance with techniques of the present disclosure.

FIGS. 2A-2C illustrate example screens of a computing device as a user interacts with the device, in accordance with one or more techniques of the present disclosure.

FIG. 3 is a block diagram illustrating further details of one example of the computing device shown in FIGS. 2A-2C.

FIG. 4 is a flow diagram illustrating a method that may be performed by a computing device in accordance with one or more techniques of the present disclosure.

### DETAILED DESCRIPTION

In general, this disclosure describes techniques for providing a user with the ability to configure a network connection between a computing device and a network device using a computer-generated image, and without having to manually set up the network connection. The network device configuration information may be encoded using a computer-generated image, which may be provided to a user for scanning with the user's computing device. These techniques allow reading of the computer-generated image by a computing device, resulting in establishing a connection with an associated network, without requiring the user to manually input network configuration parameters.

The techniques of this disclosure take advantage of the ability of computing devices to scan computer-generated images. For example, most current mobile devices incorporate cameras that may be used to capture an image, such as a computer-generated image. A mobile device may also be capable of utilizing applications that translate the image of the computer-generated image into the information encoded therein. As a result, configuring a network connection on a computing device may become less time-consuming than configuring a network connection by manually entering the configuration information that allow the user to access the network.

In one implementation, computer-generated images are barcodes, which are computer-generated images that encode data and are computer-readable. In some examples, an optical scanner may be utilized to read computer-generated images and decode the scanned image to obtain a decoded version of the data, e.g., text, product information, contact information, website address, and the like.

In some examples, barcodes may be linear or 1-dimensional images, which represent data in parallel lines and spacing between the parallel lines. A universal product code (UPC) is one example of linear or 1-dimensional barcodes, and is widely used to track items, usually in stores. The UPC encodes 12 digits as alternating bars and spaces with varying widths. In retail, each digit may have a specific meaning based on location and value, indicating such things as the type of products, country of origin, and price, for example.

In other examples, barcodes may be matrix codes or 2-dimensional images, which represent data in any one of a multitude of shapes such as squares, dots, hexagons, and other geometric patterns. Matrix code or 2-dimensional barcodes are similar to linear or 1-dimensional barcodes, but have more data representation capabilities. PDF417, QR code, and Aztec code are some examples of 2-dimensional barcodes. For example, a PDF417 barcode consists of 3 to 90 rows, each of which is a linear barcode. As another example, an Aztec code is a symbol built on a square grid with a bulls-eye pattern in the center, and data is encoded in concentric square rings around the bulls-eye pattern.

A QR code is a symbol built on a square grid with three corner square patterns that define its position. QR codes are widely used to encode a variety of information, and QR code generation websites are publicly available. Users with a computing device equipped with a camera and a reader application can capture an image of the QR code using the camera and decode it using the reader application. In one example, the QR code may encode a universal resource locator (URL), and upon scanning the QR code, the reader application may decode the code and cause the launching of a browser and redirecting to the encoded URL. In another example, the QR code may encode configuration information such as, for example, network access control information, which may include, the network's SSID name, security keys (e.g., WPA and WEP), and other network configuration information. Upon scanning the QR code, the reader application may decode the code and utilize the configuration information to configure a connection between the computing device and the network. While this disclosure discusses using QR codes, it should be understood that the techniques of this disclosure are applicable to other types of computer-generated images and barcodes.

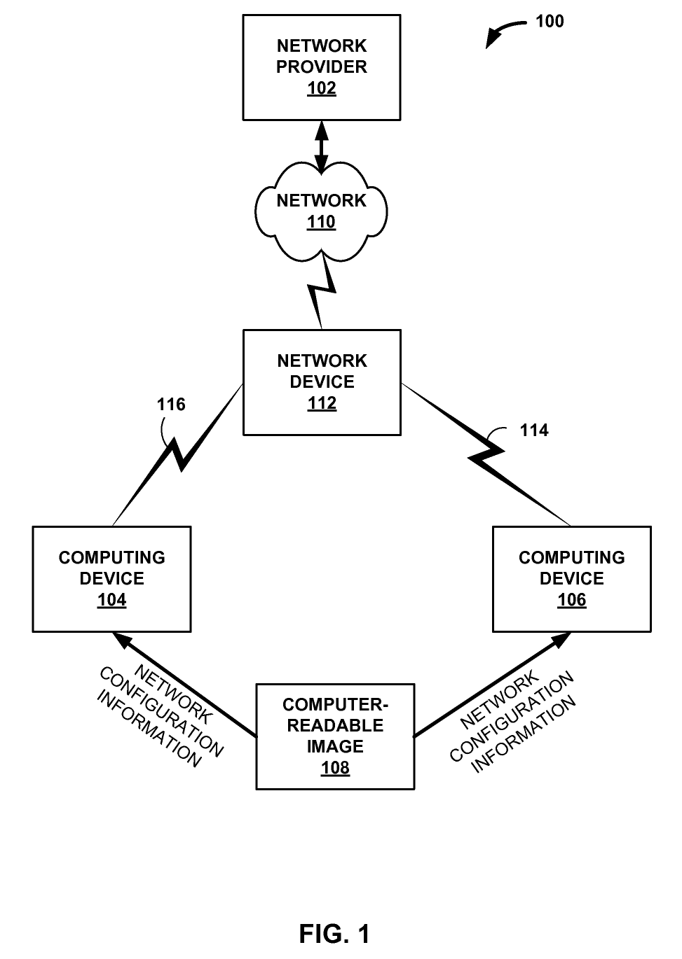

FIG. 1 is a block diagram illustrating an example system in accordance with techniques of this disclosure. In the example of FIG. 1, system 100 includes network provider 102, computing devices 104 and 106, computer-readable image 108, network 110, and network device 112. Network 110 allows access and interaction between computing devices and resources, such as networking resources (e.g., the Internet). Devices in system 100 may interact with other devices via network 110 over network connections, such as network connections 114 and 116, when properly configured to connect to network 110 through network device 112.

A subscriber to network provider 102 may provide access to network 110, e.g., the Internet, by setting up network device 112, to which devices can connect upon proper configuration to access network 110. Proper configuration of connection to the network may require locating the network, and entering the corresponding SSID and security key, both of which may be made up of long sequences of random combinations of alphanumeric characters. This may be inconvenient for the network subscriber who provides network device 112 to access network 110, and to the user of a computing device (e.g., computing device 104 or 106) who may wish to connect to the network. The inconvenience may be the result of the process of configuring a computing device with the different configuration parameters and information being time-consuming, for example, because the security key is often a long sequence of characters, and a user can easily make a mistake entering it, especially using keypads on mobile devices, which are becoming smaller. Additionally, many security keys are hexadecimal, and sometimes when the security key is dictated, errors may arise because the letters “B,” “C,” “D,” and “E” may sound similar. Often, making a mistake while typing in a sequence of characters may result in having to start the process all over again. Therefore, it may be desirable to configure a network connection without having to key in the configuration parameters.

In accordance with techniques of this disclosure, a subscriber to network provider 102 may have access to network 110 via network device 112. Network device 112 may be one or more network devices that provide the subscriber with access to network 110 and allow other users to connect to network 110. In one example, network device 112 may be a wireless router or modem. Network device 112 may be configured to provide access to network 110 to devices using configuration information associated with network device 112. Network device configuration information may be, for example, an SSID name and a security key. Each part of the configuration information may be a sequence of alphanumeric characters. The subscriber may combine all the configuration information, for example, into one sequence of characters with semicolons separating the different parts. In one example, for a system that uses the IEEE 802.11 standard, the configuration information may be combined as follows:

(WIFI:S:<name of network> ;T:<network type:WPA2/WPA/WEP> ;P:<password>;)

The information may be encoded using any type of encoding scheme, where the decoding side has knowledge of the encoding scheme or is able to determine the encoding scheme from the encoded information.

The subscriber may be an entity or a business (e.g., coffee house owner, homeowner, library network administrator, or the like) may generate a computer-generated image 108 (e.g., a QR code) that encodes the network configuration information. The computer-generated image (also referred to as a computer-readable image) 108 may be generated, for example, using any one of many available websites that generate computer-readable images (e.g., http://qrcode.kaywa.com). The computer-readable image may be generated by entering the text that a user desires to convert to QR-code, for example, and the corresponding image is generated. In one example, the subscriber may enter the configuration information as text into a computer-readable image generator and obtain, in response, a computer-generated image that is also computer-readable (e.g., QR code). The subscriber may print the generated image, display the image on a display, such as a computer screen or monitor, or store the image electronically.

In one example, the subscriber may provide the computer-generated image to customers or guests who wish to connect to the network. As noted above, the computer-generated image may comprise network configuration information that define network parameters (e.g., network name, network type, access keys, and the like), which can be used by a computing device to gain authorization to access the network to which the subscriber subscribes, e.g., network 110, via network device 112. The computer-generated image may also generally comprise access control information. The access control information may comprise the configuration information, in addition to other information, such as connection time limit (e.g., 1 hour, 24 hours, etc.) and a subscriber identifier (e.g., information associated with the subscriber). In some examples, the connection time limit may be encoded into the computer-generated image, such that the connection between the user's computing device and the network automatically terminates after the specified time limit. In some examples, the subscriber identifier may be utilized by network sources to determine the location and number of connections to the network, for tracking or statistical purposes, for example. The subscriber identifier may be, for example, a business name associated with the subscriber, an IP address, a server location, and the like.

In one example, the user may utilize a computing device 104 or 106 (e.g., a mobile phone, tablet, personal digital assistant (PDA), or the like), which may be equipped to scan computer-generated images and decode them. In one example, the user's computing device 104 or 106 may have an image capture device (e.g., camera) that device 104 or 106 can utilize to capture an image of the computer-generated image. The user's computing device 104 may also have a reader application, which launches upon capturing and scanning of the computer-generated image. The reader application may decode the scanned image and determine based on the information contained in the computer-generated image what to do next. For example, the information in the computer-generated image may be network configuration information that may cause the reader application to launch a corresponding communication application to establish a connection between computing device 104 or 106 and network 110.

The reader application reads the network configuration information encoded in the computer-generated image and initiates a network connection application. The network configuration information is then automatically input into the appropriate configuration parameter fields, and the network connection is initiated. The user may see on his computing device a message indicating that a network connection is being established. When the computing device is connected to the network corresponding to the network configuration parameters, the reader application and the image-capturing device application may automatically close and the computing device may display an indication to the user that network connection has been established. In one example, if a computing device cannot establish a network connection, the computing device may attempt to reconnect using the configuration parameters. The number of times a computing device attempts to establish a connection may be set by default or by the user, for example. When the network connection is established, computing device (e.g., computing device 104 or 106) may be connected to the network 110 through network device 112 (e.g., access point or router), and may send and receive data via a network connection (e.g., network connections 114 or 116).

In one example, when the user uses computing device 104 or 106 to scan the computer-generated image, the reader application may automatically initiate the network connection application to establish the connection using the information encoded in the scanned image. The user may not be required to do anything other than capture the computer-generated image by directing the computing device's image capture device such that the computer-generated image is scanned.

In one example, the user may utilize computing device 104 or 106 to scan and decode the computer-generated image to gain access to the network, as described above. In some examples, the user may wish to gain access to the network using another computing device (e.g., a personal computer, a tablet, a notebook, or the like), which may not be equipped with capabilities that enable scanning computer-generated images. The user may be able to transfer (e.g., directly or via a communication link) the access control information (e.g., network configuration and other information) from computing device 104 or 106 to another computing device. In one example, computing device 104 or 106 may transfer the encoded access control information, which the other computing device may decode and use to configure a network connection with network 110 using network device 112. In another example, computing device 104 or 106 may transfer the decoded access control information, which the other computing device may user to configure a network connection, without having to do any decoding.

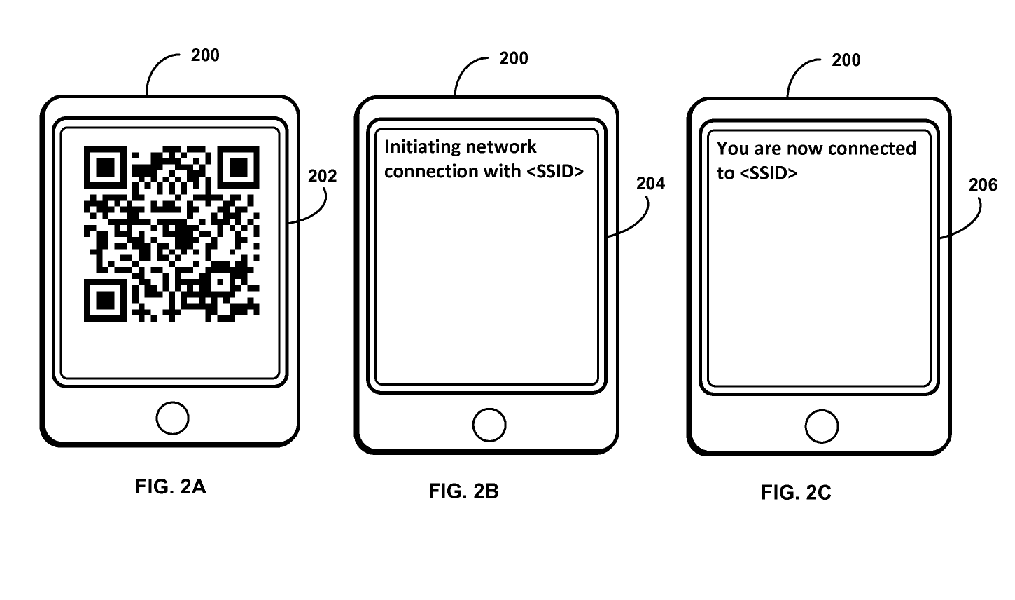

FIGS. 2A-2C illustrate example screens of a computing device as a user interacts with the device, in accordance with one or more techniques of the present disclosure. As discussed above, a computing device user may obtain a computer-generated image that encodes network configuration information. The network configuration information may be associated with a network established by a subscriber to a network, where the subscriber (e.g., business owner, network administrator, or the like) receives connection to a network and provides access to the network using a network device (e.g., access point, router, modem, and the like). The subscriber may modify the network configuration information, by creating security limitations to control access to the network, for example. In this manner, the subscriber can authorize network access by providing the computer-generated image to certain users (e.g., customers who buy something in the shop). In one example, the subscriber may encode the network configuration information into a computer-generated image, which the subscriber provides to users of computing devices (e.g., computing devices 104 and 106 of FIG. 1). As shown in the example of FIG. 2A, the user utilizes computing device 200 to scan the computer-generated image provided by a network subscriber.

Computing device 200 may be equipped with an image capture device (e.g., camera, built in scanner, infrared sensor, or the like) that the user may operate to capture an image of the computer-generated image. Computing device 200 may be, for example, a mobile phone, tablet, PDA, or the like, and may have a reader application, which may be built into computing device 200 or added by the user. Computing device 200 may also include screen 202 via which computing device 200 displays to the user application-related options and screens. In one example, screen 202 may be a touch screen that allows interaction by user's touch via user's finger or a device (e.g., stylus pen).

When the user captures the image of the computer-generated image, as shown in FIG. 2A, the captured image may be displayed on display 202. Computing device 200 may employ a processor to execute an algorithm that determines, based on the captured image that the captured image is of a barcode. The algorithm may subsequently launch the reader application, which is capable of decoding the captured image of the computer-generated image. The reader application may determine, based on the decoded information contained in the computer-generated image, to launch a communication application that configures the computing device for a network connection based on the network configuration information encoded in the computer-generated image. The network configuration information may, in some examples, be the name of the network (e.g., the SSID), the type of the network (e.g., WPA, WPA2, or WEP), and the password or pass phrase.

In one example, while the network connection is being configured and established using the network configuration information, computing device 200 may display an indication to the user. For example, the indication may be a message displayed on screen 204 indicating that network connection is being initiated with the network, as shown in FIG. 2B. The message may display the name of the network with which connection is being initiated, by display the SSID of the network, for example. When the connection with the network is established, computing device 200 may display an indication to the user that the computing device is connected. For example, the indication may be a message displayed on screen 206 indicating that the device is connected to the network identified by the network SSID, as shown in FIG. 2C. When network connection is established, the reader application and the network configuration application may terminate and computing device 200 may resume its normal functions.

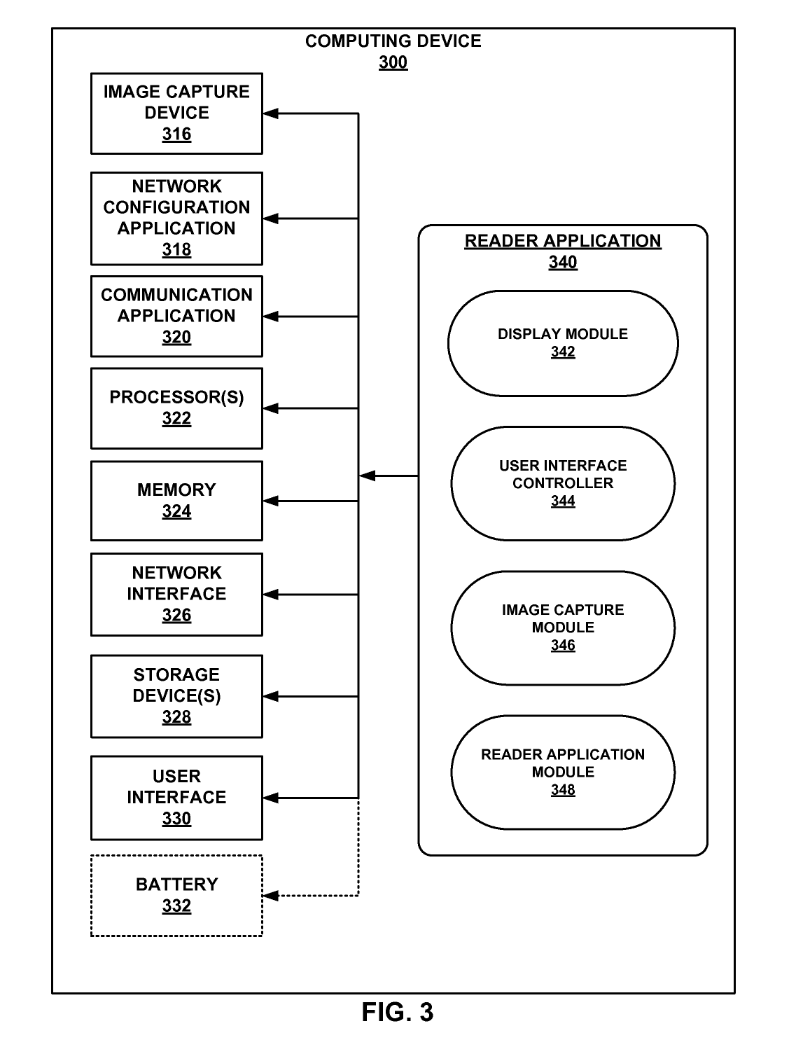

FIG. 3 is a block diagram illustrating further details of one example of the computing device shown in FIGS. 2A-2C. FIG. 3 illustrates only one particular example of computing device 300, and many other example embodiments of computing device 300 may be used in other instances. As shown in the example of FIG. 3, computing device 300 includes communication application 320, one or more processors 322, memory 324, a network interface 326, one or more storage devices 328, user interface 330, and an optional battery 332. For example, if computing device 300 comprises a mobile or portable device, computing device 300 may include battery 332. Each of components 320, 322, 324, 326, 328, 330, and 332 may be interconnected via one or more busses for inter-component communications. Processors 322 may be configured to implement functionality and/or process instructions for execution within computing device 300. Processors 322 may be capable of processing instructions stored in memory 324 or instructions stored on storage devices 328.

User interface 330 may include, for example, a monitor or other display device for presentation of visual information to a user of computing device 300. User interface 330 may further include one or more input devices to enable a user to input data, such as a manual keyboard, mouse, touchpad, trackpad, etc. In some examples, user interface 330 may comprise a touchscreen, which may be used both to receive and process user input and also to display output information and application-specific options. User interface 330 may further include printers or other devices to output information. In various instances in the description contained herein, references made to user interface 330 may refer to portions of user interface 330 (e.g., keyboard, touch screen, mouse device) that provide user input functionality.

Memory 324 may be configured to store information within computing device 300 during operation. Memory 324 may, in some examples, be described as a computer-readable storage medium. In some examples, memory 324 is a temporary memory, meaning that a primary purpose of memory 324 is not long-term storage. Memory 324 may also be described as a volatile memory, meaning that memory 324 does not maintain stored contents when the computer is turned off. Examples of volatile memories include random access memories (RAM), dynamic random access memories (DRAM), static random access memories (SRAM), and other forms of volatile memories known in the art. In some examples, memory 324 may be used to store program instructions for execution by processors 322. Memory 324 may be used by software or applications running on computing device 300 (e.g., reader application) to temporarily store information during program execution.

Storage devices 328 may also include one or more computer-readable storage media. Storage devices 328 may be configured to store larger amounts of information than memory 324. Storage devices 328 may further be configured for long-term storage of information. In some examples, storage devices 328 may comprise non-volatile storage elements. Examples of such non-volatile storage elements may include magnetic hard discs, optical discs, floppy discs, flash memories, or forms of electrically programmable memories (EPROM) or electrically erasable and programmable (EEPROM) memories.

Computing device 300 also includes network interface 326. Computing device 300 may utilize network interface 326 to communicate with external devices (e.g., one or more servers, web servers, network provider 102) via one or more networks (e.g., network 110 of FIG. 1). The network interface 326 allows computing device 300 to connect to a network for which network interface 326 is configured using the network configuration information associated with the network.

Computing device 300 also includes network configuration application 318 and communication application 320. In one example, communication application 320 may include applications available on computing device 300 that a user of computing device 300 may utilize for communicating. Communication application 320 may include, for example, voice- and/or text-based application, such as SMS messaging, e-mail, telephone capabilities, and the like. Network configuration application 318 may utilize network configuration information to configure network connections. In one example, a user of computing device 300 may manually input the network configuration information. In another example, reader application 340 may provide network configuration application 318 with network configuration information encoded in a computer-generated image that is scanned by computing device 300 and decoded by reader application 340.

Computing device 300 also includes image capture device 316. Various applications may utilize image capture device 316, where image-capturing capabilities may be needed. In one example, image-capturing capabilities may be utilized by computing device 300 to scan in and read computer-readable or computer-generated images.

Any applications implemented within or executed by computing device 300 (e.g., reader application) may be implemented or contained within, operable by, executed by, and/or be operatively coupled to processors 322, memory 324, network interface 326, storage devices 328, and/or user interface 330.

One example of reader application 340 is shown in FIG. 3. Reader application 340 may include a display module 342, a user interface controller 344, an image capture module 346, and a reader application module 348. Reader application 340 may include image capture module 346, which controls image capture device 316 to scan in and read computer-readable or computer-generated images, such as barcodes, as discussed above. Reader application 340 may be stored in memory 324 and/or storage devices 330, and may be operable by processors 322 to perform various tasks during execution.

In one example, during implementation or execution of reader application 340, image capture module 346 may be operable by processors 322 to capture an image. Display module 342 may be also operable by processors 322 to display the image captured by the image capture module. Image capture module 346 may be capable of detecting whether the captured image is a computer-generated image such as, for example, a QR code as shown in FIG. 2A. Reader application module 348 may be launched by processors 322 if image capture module 346 determines that a captured image is a computer-generated image. Reader application module 348 may be operable by processor 322 to decode an image determined to be a computer-generated image and launch an application corresponding to the information encoded in the computer-generated image. Reader application module 348 may decode the computer-generated image to determine the information contained therein, and launch the appropriate application. For example, if the computer-generated image contains network configuration information, reader application module 348 may launch a network configuration application 318 associated with network interface 326 to utilize the network configuration information to configure network interface 326 to connect computing device 300 to the corresponding network.

User interface controller 344 may be operable by processors 322 to display information to the user. For example, user interface controller 344 may display messages to the user regarding the connectivity of computing device 300 to a network. For example, during configuration of network interface 320 using the network configuration information encoded in the computer-generated image, user interface controller 344 may cause the display of a message indicating that network connection is being initiated. User interface controller 344 may also display a message to the user when the network connection is established. User interface controller 344 may resume normal display when the network connection is established and the user can resume operating applications on computing device 300 as desired, including applications that require network connectivity.

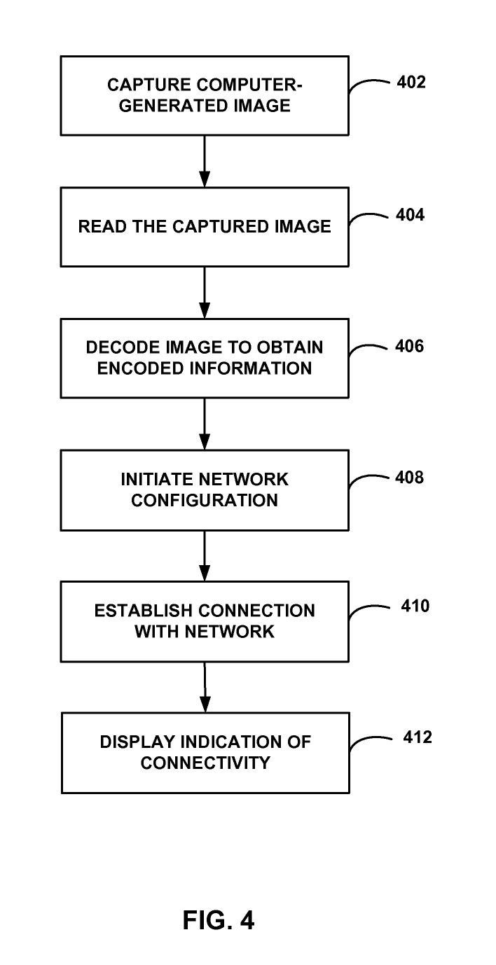

FIG. 4 is a flow diagram illustrating a method that may be performed by a computing device in accordance with one or more techniques of the present disclosure. For example, the illustrated example method may be performed by computing device 200 (FIGS. 2A-2C) or computing device 300 (FIG. 3). In some examples, a computer-readable storage medium (e.g., a medium included in storage device 328 of FIG. 3, memory 324) may be encoded with instructions that, when executed, cause one or more processors (e.g., processor 322) to perform one or more of the acts illustrated in the method of FIGS. 2A-2C, and 3.

The method of FIG. 4 includes capturing, using an image capture device of a user's computing device, an image of a computer-generated image, where the computer-generated image is computer-readable (402). The computer-generated image may be generated by a subscriber to a network provider. The subscriber may have access to a network provided by the network provider through a network device (e.g., modem). The network device may be configured to provide network access to other devices connected to the network device. For example, the network device may be a wireless router, which may have associated configuration information that can be used to configure computing devices (e.g., mobile phone, PDA, computer, etc.) to establish connection to the network. The subscriber may generate the computer-generated image (e.g., QR code) to encode the network configuration information. The network configuration information may be, for example, a name that identifies the network device, the type of network, and a password or pass phrase to access the network. The subscriber may provide the computer-generated image to the user of the computing device that captures the image.

The method further includes reading the captured image by a reader application running on the computing device (404). The reader application may read the captured image by decoding the image to obtain the encoded information (406). The obtained information may be the network configuration information, which when used to configure the computing device, provide network access to the computing device.

The method also includes initiating network configuration by utilizing the decoded information (408). As described above, the information in the computer-generated image may be network configuration information that may cause the reader application to launch a corresponding network configuration/communication application to establish a connection between the computing device and the corresponding network. The reader application may cause automatic input of the network configuration information into the appropriate configuration parameter fields to initiate connecting to the network.

When the computing device establishes a connection with the network (410) corresponding to the network configuration information, the reader application and the image-capturing device application may automatically close and the computing device may display an indication of connectivity to the user that network connection has been established (412). In one example, if a computing device cannot establish a network connection, the computing device may attempt to reconnect using the configuration parameters. The number of times a computing device attempts to establish a connection may be set by default or by the user, for example. If connection cannot be established, an indication regarding inability to connect to the network may be displayed to the user.

The techniques described in this disclosure may be implemented, at least in part, in hardware, software, firmware, or any combination thereof. For example, various aspects of the described techniques may be implemented within one or more processors, including one or more microprocessors, digital signal processors (DSPs), application specific integrated circuits (ASICs), field programmable gate arrays (FPGAs), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry. A control unit including hardware may also perform one or more of the techniques of this disclosure.

Such hardware, software, and firmware may be implemented within the same device or within separate devices to support the various techniques described in this disclosure. In addition, any of the described units, modules or components may be implemented together or separately as discrete but interoperable logic devices. Depiction of different features as modules or units is intended to highlight different functional aspects and does not necessarily imply that such modules or units must be realized by separate hardware, firmware, or software components. Rather, functionality associated with one or more modules or units may be performed by separate hardware, firmware, or software components, or integrated within common or separate hardware, firmware, or software components.

The techniques described in this disclosure may also be embodied or encoded in a computer-readable medium, such as a computer-readable storage medium, containing instructions. Instructions embedded or encoded in a computer-readable medium, including a computer-readable storage medium, may cause one or more programmable processors, or other processors, to implement one or more of the techniques described herein, such as when instructions included or encoded in the computer-readable medium are executed by the one or more processors. Computer readable storage media may include random access memory (RAM), read only memory (ROM), programmable read only memory (PROM), erasable programmable read only memory (EPROM), electronically erasable programmable read only memory (EEPROM), flash memory, a hard disk, a compact disc ROM (CD-ROM), a floppy disk, a cassette, magnetic media, optical media, or other computer readable media. In some examples, an article of manufacture may comprise one or more computer-readable storage media.

In some examples, a computer-readable storage medium may comprise a non-transitory medium. The term “non-transitory” may indicate that the storage medium is not embodied in a carrier wave or a propagated signal. In certain examples, a non-transitory storage medium may store data that can, over time, change (e.g., in RAM or cache).

Various embodiments of the disclosure have been described. These and other embodiments are within the scope of the following claims.

1. A method comprising:
scanning, by a first computing device, a computer-readable image that includes encoded access control information associated with a network device that provides access to a network, wherein the access control information comprises one or more network parameters used by the network device to authorize access to the network;
decoding, by the first computing device, the encoded access control information to obtain the access control information; and
configuring the first computing device with the decoded access control information, wherein the configured first computing device is able to access the network using the network device,
wherein the access control information comprises an identifier associated with an entity that controls the network device, and
wherein the identifier comprises information corresponding to a business associated with the entity.

2. The method of claim 1, wherein the access control information comprises network configuration information.

3. The method of claim 2, wherein the encoded access control information comprises an encoded representation of the network configuration information.

4. The method of claim 3, wherein the encoded representation of the network configuration information comprises an encoded string of characters representing the network configuration information.

5. The method of claim 4, wherein decoding the encoded access control information comprises parsing the encoded string of characters to obtain the network configuration information.

6. The method of claim 1, wherein the one or more network parameters identifies the network, such that the first computing device is capable of utilizing the one or more network parameters to connect to the network using the network device.

7. The method of claim 1, wherein the one or more network parameters comprises one or more of a network name, one or more access keys, and a network type.

8. The method of claim 1, wherein a subscriber to the network generates the computer-readable image.

9. The method of claim 1, wherein the access control information comprises a connection time limit, and wherein the method further comprises terminating a network connection after a time equal to the connection time limit elapses.

10. (canceled)

11. (canceled)

12. The method of claim 10, wherein the identifier comprises an Internet Protocol address.

13. The method of claim 10, wherein the computer-readable image is generated by the entity.

14. The method of claim 10, wherein the computer-readable image is displayed by the entity, such that the computer-readable image is provided to a user of the first computing device.

15. The method of claim 1, further comprising:
communicating, by the first computing device, the decoded access control information to a second, different computing device,
wherein the second computing device is configured to connect to the network using the network device based on the decoded access control information.

16. The method of claim 1, further comprising:
communicating, by the first computing device, the encoded access control information to a second computing device,
such that the second computing device is capable of decoding the encoded access control information to obtain the access control information and connect to the network using the network device based on the decoded access control information.

17. The method of claim 1, wherein the first computing device comprises a mobile phone.

18. The method of claim 1, wherein the computer-readable image comprises one of a 1-dimensional or a 2-dimensional barcode.

19. A non-transitory computer-readable storage medium encoded with instructions that, when executed, cause one or more processors to:
scan, by a first computing device, a computer-readable image that includes encoded access control information associated with a network device that provides access to a network, wherein the access control information comprises one or more network parameters used by the network device to authorize access to the network;
decode, by the first computing device, the encoded access control information to obtain the access control information; and
configure the first computing device with the decoded access control information, wherein the configured first computing device is able to access the network using the network device,
wherein the access control information comprises an identifier associated with an entity that controls the network device, and
wherein the identifier comprises information corresponding to a business associated with the entity.

20. A computing device, comprising:
one or more processors;
an image capture module operable by the one or more processors to scan a computer-readable image that includes encoded access control information associated with a network device that provides access to a network, wherein the access control information comprises one or more network parameters used by the network device to authorize access to the network;
a module operable by the one or more processors to decode the encoded access control information to obtain the access control information; and
means for configuring the computing device with the decoded access control information, wherein the configured computing device is able to access the network using the network device,
wherein the access control information comprises an identifier associated with an entity that controls the network device, and
wherein the identifier comprises information corresponding to a business associated with the entity.

21. A computing device, comprising:
one or more processors;
an image capture module operable by the one or more processors to scan a computer-readable image that includes encoded access control information associated with a network device that provides access to a network, wherein the access control information comprises one or more network parameters used by the network device to authorize access to the network;
a reader application module operable by the one or more processors to decode the encoded access control information to obtain the access control information; and
a network configuration application operable by the one or more processors to configure the computing device with the decoded access control information, wherein the configured computing device is able to access the network using the network device,
wherein the access control information comprises an identifier associated with an entity that controls the network device, and
wherein the identifier comprises information corresponding to a business associated with the entity.
